(19) United States
(12) Patent Application Publication
(10) Pub. No.: US 2026/0342543 A1
(43) Pub. Date: Oct. 29, 2026

(54) SECURE DEVICE ONBOARDING FOR DISTRIBUTED ARCHITECTURES

(71) Applicant: Dell Products L.P., Round Rock, TX (US)

(72) Inventors: Kah Wai Au, Singapore (SG); Jia Yuan Chia, Singapore (SG)

(21) Appl. No.: 19/188,618

(22) Filed: Apr. 24, 2025

(51) Int. Cl. H04L 9/08; H04L 9/32

(52) U.S. Cl. CPC H04L 9/0825; H04L 9/0841; H04L 9/3297

(57) ABSTRACT

Methods, apparatus, and processor-readable storage media for secure device onboarding are provided herein. An exemplary computer-implemented method includes sending an executable beacon to a target device in a distributed computing environment, where the executable beacon is configured to communicate with a receiver associated with a processor-based orchestrator of the distributed computing environment. The method includes obtaining data associated with one or more device characteristics of the target device, where the data is obtained at the receiver from the executable beacon on the target device, and evaluating the one or more device characteristics relative to one or more onboarding criteria. The method further includes generating onboarding instructions for the target device based at least in part on a result of the evaluating, sending the onboarding instructions to the target device and establishing a secure communication channel with the target device by initiating an execution of the onboarding instructions.

### BACKGROUND

Device requirements in computing environments are typically evolving as new technologies are introduced. Existing devices in such computing environments often fail to meet these evolving requirements.

### SUMMARY

Illustrative embodiments of the disclosure provide techniques for secure device onboarding. An exemplary computer-implemented method includes sending an executable beacon to at least one target device in a distributed computing environment, where the executable beacon is configured to communicate with a receiver associated with a processor-based orchestrator of the distributed computing environment. The method includes obtaining data associated with one or more device characteristics of the at least one target device, where the data is obtained at the receiver from the executable beacon on the at least one target device, and evaluating the one or more device characteristics relative to one or more onboarding criteria. The method further includes generating one or more onboarding instructions for the target device based at least in part on a result of the evaluating, sending the one or more onboarding instructions to the target device and establishing a secure communication channel with the at least one target device by initiating an execution of the one or more onboarding instructions.

Illustrative embodiments can provide significant advantages relative to conventional techniques. For example, technical problems associated with utilizing target (e.g., legacy) devices in distributed computing architectures are mitigated in one or more embodiments by leveraging lightweight beacons to onboard the target devices. Some embodiments can establish secure communication channels between beacons and receivers, enabling policy-driven validation of collected device characteristics. Such embodiments can enable scalable onboarding processes while mitigating security risks through ephemeral key pairs that expire after a defined period.

These and other illustrative embodiments described herein include, without limitation, methods, apparatus, systems and computer program products comprising processor-readable storage media.

### BRIEF DESCRIPTION OF THE DRAWINGS

FIG. 1 shows an information processing system configured for secure device onboarding for distributed architectures in an illustrative embodiment.

FIG. 2 shows a system architecture in an illustrative embodiment.

FIGS. 3A and 3B show a signaling diagram between a beacon and a receiver in an illustrative embodiment.

FIG. 4 shows a flow diagram of a process for secure device onboarding in an illustrative embodiment.

FIGS. 5 and 6 show examples of processing platforms that may be utilized to implement at least a portion of an information processing system in illustrative embodiments.

### DETAILED DESCRIPTION

Illustrative embodiments will be described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources.

As computing requirements evolve, integrating legacy devices into modern distributed computing systems presents significant challenges. Updating older hardware to meet new demands is often impractical due to limitations in processing power, memory and/or security capabilities. Organizations must therefore balance the benefits of new technologies against the difficulty of incorporating existing infrastructure.

The term “distributed computing environment,” as used herein, is intended to be broadly construed so as to encompass any system comprising multiple interconnected computational resources (e.g., processing, storage and/or networking resources). This includes, but is not limited to, edge computing deployments, cloud computing environments, and/or hybrid computing environments combining on-premise resources with cloud capabilities. Such environments are often characterized by the distribution of computational tasks across various physical locations and/or virtual instances.

The term “endpoint device,” as used herein, is intended to be broadly construed so as to include computing devices that are often deployed closer to data sources to minimize latency, protect data privacy and/or improve resource use. As a non-limiting example, a computing endpoint device may serve as an edge computing endpoint in an edge computing architecture, where the computing endpoint operates with secure communication protocols established with at least one other entity in the edge computing environment, such as an edge orchestrator.

The term “target device” as used herein is intended to be broadly construed, so as to encompass, for example, endpoint devices that may not natively support integration into a distributed computing environment but can be adapted or interfaced to contribute to such systems. As non-limiting examples, a target device may include a brownfield device, a legacy device and/or existing hardware and/or software solutions. In some embodiments, target devices may lack the capability of establishing secure communication with an edge orchestrator, for example.

In the context of distributed computing environments, such as edge computing deployments, onboarding and integrating new devices present significant technical challenges. For example, conventional techniques can be slow and inefficient, often requiring significant time for large-scale deployments. Such techniques also frequently rely on heavy payloads and complex client installations, introducing substantial security risks due to potential vulnerabilities and attack vectors. Furthermore, adapting devices that lack native support for modern protocols is technically challenging, often necessitating manual configurations and potentially compromising device performance and/or security. The limited resources available on many edge devices exacerbate these issues, making it difficult to deploy updates or implement robust security measures without impacting functionality.

Some embodiments described herein can effectively address at least some of these technical challenges by leveraging an efficient onboarding process with secure communication. Such embodiments can enable scalable and secure integration of target devices without requiring extensive client installations or compromising device performance.

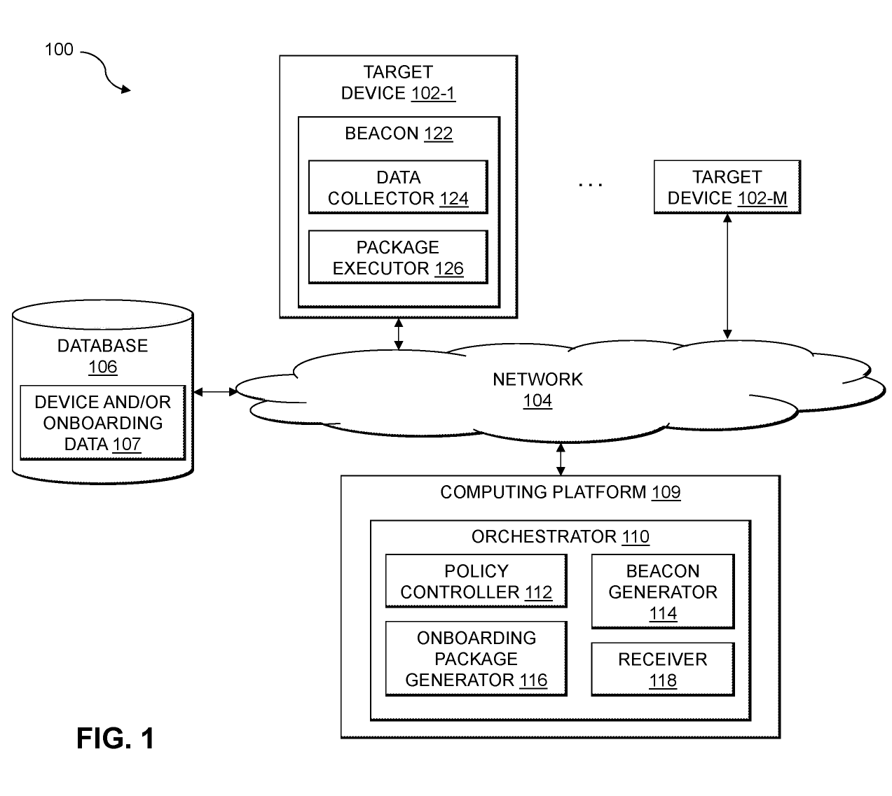

FIG. 1 shows an information processing system 100 configured in accordance with an illustrative embodiment. The information processing system 100 comprises a plurality of target devices 102-1 . . . 102-M (collectively referred to herein as target devices 102), which are coupled to a network 104. Also coupled to network 104 is at least one computing platform 109 comprising at least one orchestrator 110.

The target devices 102 may comprise, for example, servers and/or portions of one or more server systems, as well as devices such as mobile telephones, laptop computers, tablet computers, desktop computers or other types of computing devices. Such devices are examples of what are more generally referred to herein as “processing devices.” Some of these processing devices are also generally referred to herein as “computers.”

The target devices 102 in some embodiments comprise respective computers associated with a particular company, organization or other enterprise. In addition, at least portions of the information processing system 100 may also be referred to herein as collectively comprising an “enterprise network.” Numerous other operating scenarios involving a wide variety of different types and arrangements of processing devices and networks are possible, as will be appreciated by those skilled in the art.

The target devices 102 in some embodiments can be associated with one or more users. It is to be appreciated that the term “user” in this context and elsewhere herein is intended to be broadly construed so as to encompass, for example, human, hardware, software or firmware entities, as well as various combinations of such entities.

In the FIG. 1 embodiment, the target device 102-1 includes a beacon 122 comprising a data collector 124 and a package executor 126.

The beacon 122 generally is configured to communicate with a receiver 118 of the orchestrator 110, collect device information and transmit the information via the data collector 124 and execute onboarding packages received from the orchestrator 110. In some embodiments, the beacon 122 can be a self-contained software package executable by a processor of the target device 102-1, for example.

The data collector 124 is configured to collect various types of device-specific information including, but not limited to, hardware configurations, software versions, running processes, network settings, security posture details (e.g., antivirus status) and/or system logs. The collected data is transmitted to the receiver 118 on the orchestrator 110.

The package executor 126 is configured to receive and execute onboarding packages provided by the orchestrator 110, install necessary software components, configure system settings, and establish secure communication channels with the orchestrator 110.

It is to be appreciated that this particular arrangement of elements 122, 124 and 126 illustrated in the target device 102-1 of the FIG. 1 embodiment is presented by way of example only, and alternative arrangements can be used in other embodiments. For example, the functionality associated with the elements 122, 124 and 126 in other embodiments can be combined into a single module or separated across a larger number of modules. As another example, multiple distinct processors can be used to implement different ones of the elements 122, 124 and 126 or portions thereof.

At least portions of elements 122, 124 and 126 may be implemented at least in part in the form of software that is stored in memory and executed by a processor.

The network 104 is assumed to comprise a portion of a global computer network such as the Internet, although other types of networks can be part of the information processing system 100, including a wide area network (WAN), a local area network (LAN), a satellite network, a telephone or cable network, a cellular network, a wireless network such as a Wi-Fi or WiMAX network, or various portions or combinations of these and other types of networks.

The orchestrator 110 of the computing platform 109 can have at least one associated database 106 configured to store device and/or onboarding data 107 pertaining to, for example, onboarding criteria, device identifiers, collected configuration information, compliance status with the onboarding criteria, onboarding history, security vulnerability assessments and/or application deployment details associated with one or more of the target devices 102.

An example database 106, such as depicted in the present embodiment, can be implemented using one or more storage systems associated with the computing platform 109. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the computing platform 109 are one or more input-output devices, which illustratively comprise keyboards, displays or other types of input-output devices in any combination. Such input-output devices can be used, for example, to support one or more user interfaces to the computing platform 109, as well as to support communication between the computing platform 109, the target devices 102 and/or other related systems and devices not explicitly shown.

Additionally, the computing platform 109 in the FIG. 1 embodiment is assumed to be implemented using at least one processing device. Each such processing device generally comprises at least one processor and an associated memory, and implements one or more functional modules for controlling certain features of the computing platform 109.

More particularly, the computing platform 109 in this embodiment can comprise a processor coupled to a memory and a network interface.

The processor illustratively comprises a microprocessor, a microcontroller, an application-specific integrated circuit (ASIC), a field-programmable gate array (FPGA) , a central processing unit (CPU), a graphical processing unit (GPU), a tensor processing unit (TPU), a video processing unit (VPU), a neural processing unit (NPU), a data processing unit (DPU), a System-On-Chip (SOC) or other type of processing circuitry, as well as portions or combinations of such circuitry elements.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage drive, a storage array or an integrated circuit containing memory, as well as a wide variety of other types of computer program products. The term “article of manufacture” as used herein should be understood to exclude transitory, propagating signals. These and other references to “drives” herein are intended to refer generally to storage devices, including solid-state drives (SSDs), and should therefore not be viewed as limited in any way to particular storage media types.

The network interface allows the computing platform 109 to communicate over the network 104 with the target devices 102 and/or the at least one computing platform 109, and illustratively comprises one or more conventional transceivers.

The at least one orchestrator 110, in some embodiments, can be deployed on the at least one computing platform 109, which may correspond to one or more data centers and/or a cloud computing environment, as non-limiting examples. Generally, the computing platform 109 comprises infrastructure and/or resources for supporting the operation of the orchestrator 110. As used herein, the term “orchestrator” (also referred to as a processor-based orchestrator) shall be broadly construed to encompass, for example, an orchestrator that is accessible to target devices, and should not be construed to require any particular locational relationship relative to the target devices, as would be apparent to a person of ordinary skill in the art.

In some embodiments, the at least one orchestrator 110 generally is responsible for managing resources and workloads within a designated domain (typically a geographically localized network segment and/or a designated group of computing endpoints, which may include one or more of the target devices 102, for example). In some embodiments, the at least one orchestrator may be deployed in an edge computing environment and may be referred to as an edge orchestrator.

In the FIG. 1 embodiment, the orchestrator 110 includes a policy controller 112, a beacon generator 114, an onboarding package generator 116 and a receiver 118.

The policy controller 112 generally is configured to evaluate data received from target devices 102 via the receiver 118 against designated security policies and/or onboarding criteria stored in database 106, for example. The policy controller 112 may determine whether a given one of the target devices 102 can be securely onboarded.

The beacon generator 114 is configured to generate beacons (such as beacon 122) that can be deployed on the target devices 102. In some embodiments, the beacons can include information for securely onboarding the target devices 102, such as an address of the receiver 118, cryptographic key information, expiry timestamps, and data collection parameters aligned with onboarding criteria established by the policy controller 112. The beacons can be deployed onto the target devices 102, where they execute to collect device-specific information for onboarding validation. According to at least some embodiments, the beacons generated by the beacon generator 114 lack any type of sensitive data and can terminate based on the expiry timestamps. In some embodiments, each of the beacons can be lightweight, self-contained software to ensure easy deployment without needing to be pre-installed and/or configured.

The onboarding package generator 116 is configured to create onboarding packages for one or more of the target devices 102. The onboarding packages may include any information necessary for onboarding the target devices 102 including, for example, software components, configuration files and/or settings, security updates, and/or firmware updates. In at least some embodiments, the onboarding packages may be customized for each one of the target devices 102 that are approved by the policy controller 112.

The receiver 118 is configured to securely receive data transmitted by the beacon 122 on the target device 102-1. In some embodiments, the receiver 118 establishes a secure communication channel with one or more of the target devices 102, as explained in more detail elsewhere herein.

It is to be appreciated that this particular arrangement of elements 110, 112, 114, 116 and 118 illustrated in the computing platform 109 of the FIG. 1 embodiment is presented by way of example only, and alternative arrangements can be used in other embodiments. For example, the functionality associated with the elements 110, 112, 114, 116 and 118 in other embodiments can be combined into a single module or separated across a larger number of modules. As another example, multiple distinct processors can be used to implement different ones of the elements 110, 112, 114, 116 and 118 or portions thereof.

At least portions of elements 110, 112, 114, 116 and 118 may be implemented at least in part in the form of software that is stored in memory and executed by a processor.

It is to be understood that the particular set of elements shown in FIG. 1 for target devices 102 involving the orchestrator 110 of the information processing system 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, one or more of the target devices 102, the orchestrator 110 and/or the database 106 can be on and/or part of the same processing platform.

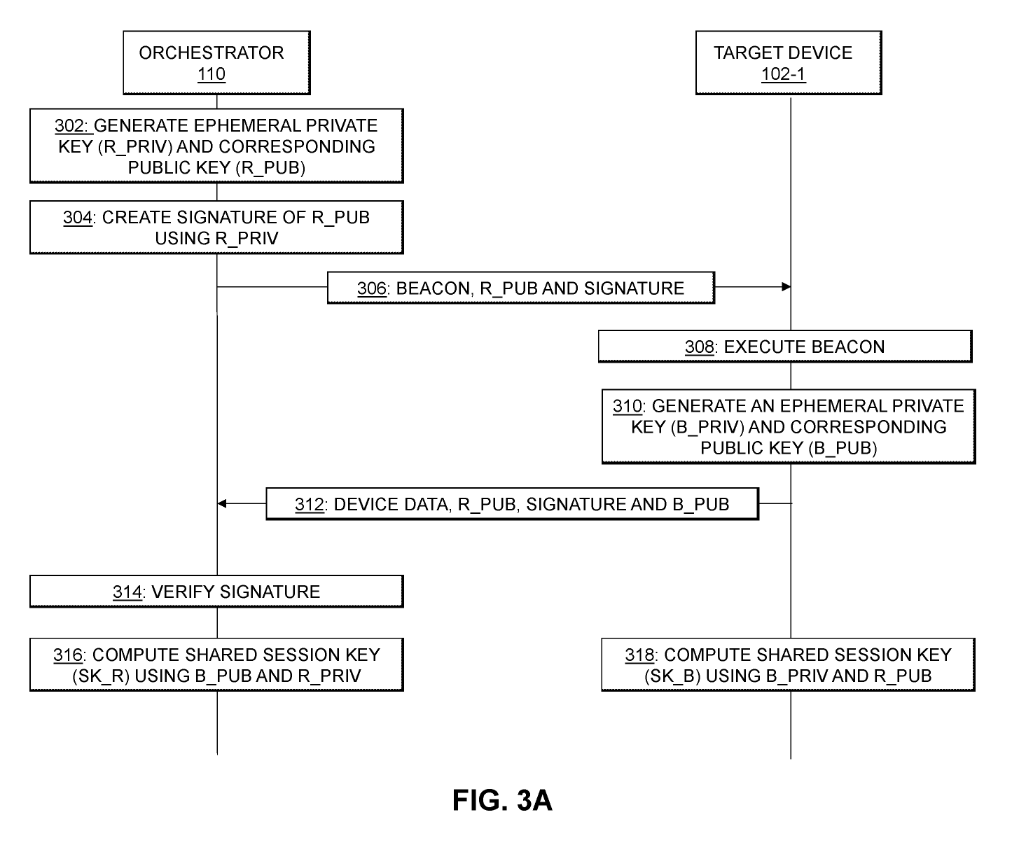

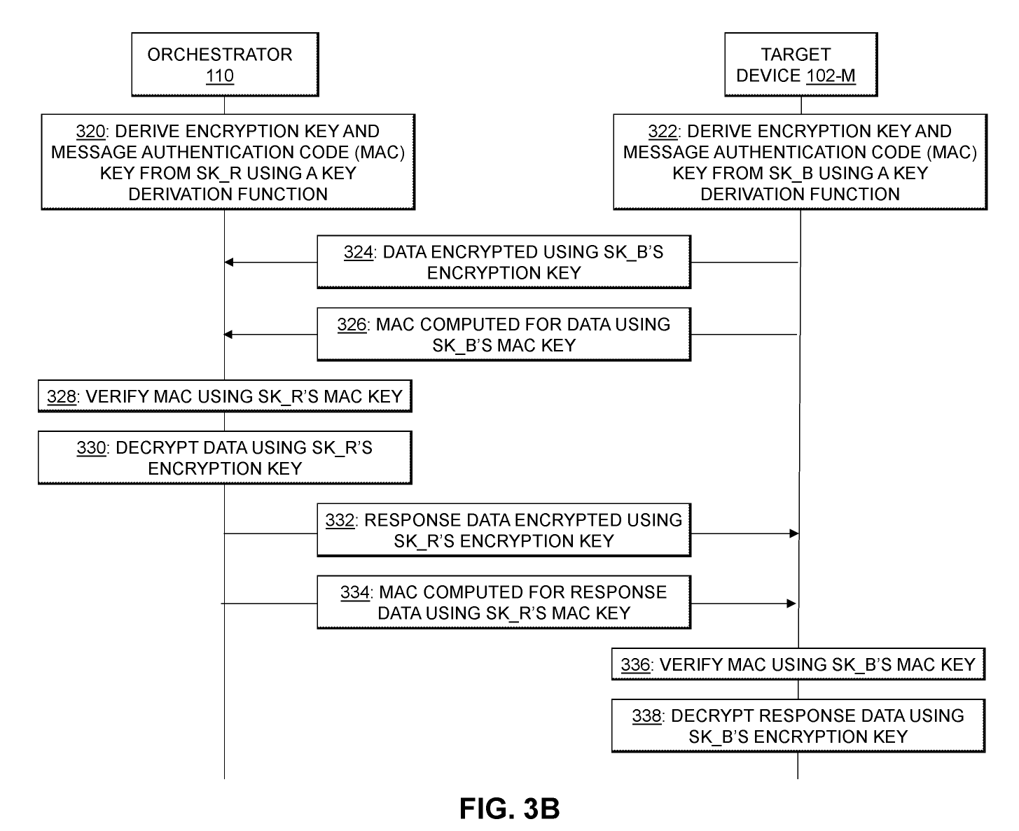

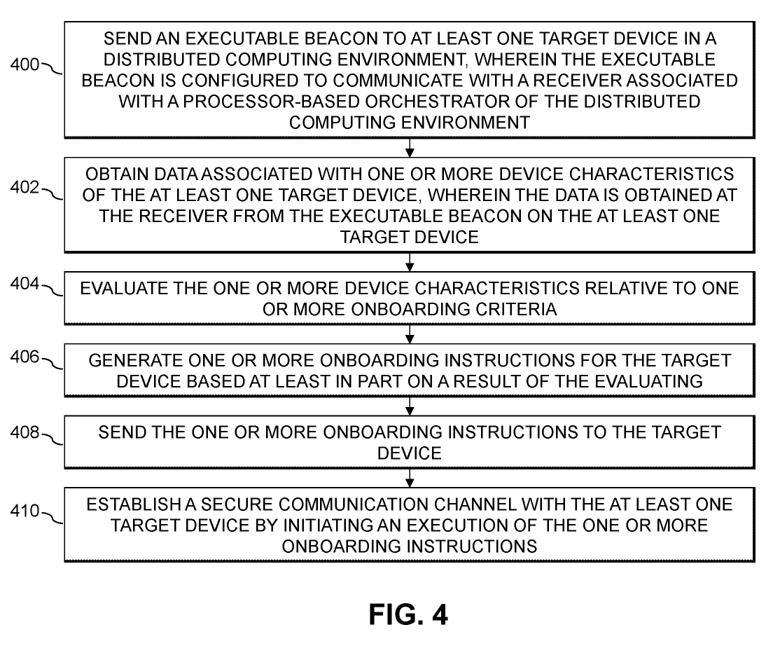

An exemplary process utilizing elements 112, 114 and 116 of an example orchestrator 110 in the information processing system 100 will be described in more detail with reference to, for example, the diagrams of FIGS. 3A-3B and 4.

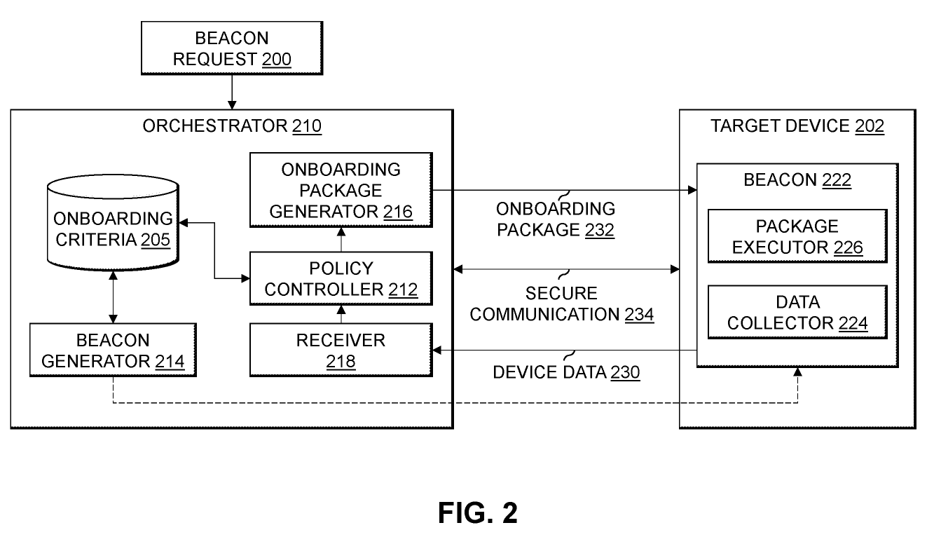

Referring now to FIG. 2, this figure shows a system architecture including an orchestrator 210 (e.g., corresponding to orchestrator 110) and a target device 202 (e.g., corresponding to target device 102-1) in accordance with an illustrative embodiment. The orchestrator 210 obtains a beacon request 200, which may be provided by a user, for example. The beacon request 200 can specify desired data collection parameters and onboarding requirements for onboarding the target device 202, which can be saved as onboarding criteria 205.

As depicted in FIG. 2, the orchestrator 210 comprises a policy controller 212, a beacon generator 214, an onboarding package generator 216 and a receiver 218. In response to receiving the beacon request 200, the beacon generator 214 generates a beacon 222, which is deployed on the target device 202 as indicated by the dashed arrow. In some embodiments, the beacon 222 can be downloaded from the orchestrator 210 by a user, which the user can then deploy on the target device 202, for example.

In the example of FIG. 2, the target device 202 comprises the deployed beacon 222 that further comprises a data collector 224 and a package executor 226. The beacon 222, using its data collector 224, collects device data 230 corresponding to the onboarding criteria 205. For example, the device data 230 can relate to hardware configurations, software versions, security details, and/or other information that is relevant for onboarding the target device 202 such as basic input/output system information (BIOS) and log information. The device data 230 is transmitted to the receiver 218.

The policy controller 212 validates the device data 230 against the onboarding criteria 205. As a non-limiting example, the onboarding criteria 205 may include thresholds and/or rules for validating the device data 230. If the device data passes validation, then the policy controller 212 triggers the onboarding package generator 216 to generate an onboarding package 232 for the target device 202. The onboarding package 232 is then provided to the target device 202. The onboarding package 232 is executed by the package executor 226, which onboards the target device 202 by establishing secure communication 234 with the orchestrator 210. An example of a process for establishing the secure communication 234 is now described in more detail in conjunction with FIGS. 3A and 3B (collectively FIG. 3).

FIGS. 3A and 3B show a signaling diagram between the orchestrator 110 and the target device 102-1, demonstrating a key agreement process for secure channel communication in accordance with an illustrative embodiment. In some embodiments, the key agreement process comprises an Elliptic Curve Diffie-Hellman (ECDH) key agreement process, for example.

At step 302, the orchestrator 110 generates an ephemeral private key (R_priv) and a corresponding public key (R_pub). The receiver key pair (R_priv, R_pub) is unique to a particular beacon instance. In at least some embodiments, the receiver key pair has the same expiry as the beacon, which will become invalid upon expiration.

Step 304 includes the orchestrator 110 creating a signature of R_pub using its private key (R_priv). The signature is used to ensure the authenticity and integrity of R_pub.

Step 306 includes deploying a beacon with R_pub and the signature to the target device 102-1. As noted elsewhere herein, the beacon may also include other information such as the receiver address, a unique beacon identifier, an expiration timestamp and configuration instructions for collecting device data.

At step 308, the target device 102-1 executes the beacon. The execution of the beacon triggers device data to be collected from the target device 102-1.

Step 310 includes the target device 102-1 generating a beacon ephemeral private key (B_priv) and a corresponding public key (B_pub). In some embodiments, the beacon key pair is generated each time the beacon initiates communication with the orchestrator 110.

Step 312 includes the target device 102-1 sending the device data along with R_pub, the signature and B_pub to the orchestrator 110. The orchestrator verifies the signature at step 314 to confirm that R_pub was generated by the orchestrator’s private key.

Step 316 includes the orchestrator 110 computing a shared session key (SK_R) using B_pub and R_priv.

Step 318 includes the target device 102-1 computing a shared session key (SK_B) using B_priv and R_pub, resulting in SK_R = SK_B.

In some embodiments, SK_R is computed as R_priv ∙ B_pub, and SK_B is computed as B_priv ∙ R_pub.

For embodiments using an ECDH key agreement process, the shared session keys are mathematically equivalent as the shared session keys are derived from the same elliptic curve parameters. For example, SK_R = SK_B = R_priv * B_priv * G, where G corresponds to a designated generator point on the elliptic curve. In some embodiments, G can be established for a particular beacon-receiver pair when the beacon is generated. G can be included as metadata in the beacon, and the receiver can store G with its ephemeral key pair, for example. G can be generated using elliptic curves such as secp256k1.

As shown in FIG. 3B, step 320 includes the orchestrator 110 deriving an encryption key and a message authentication code (MAC) key from SK_R using a key derivation function (KDF). In some embodiments, the KDF may utilize a hash-based MAC (HMAC)-based extract-and-expand (HKDF) algorithm. At step 322, the target device 102-1 also derives an encryption key and a MAC key from SK_R using the same KDF.

The derived encryption keys and the MAC keys are used to encrypt and authenticate messages exchanged between the target device 102-1 and the orchestrator 110. Specifically, at step 324, the target device 102-1 transmits encrypted data using its encryption key (e.g., SK_B’s encryption_key). At step 326, the target device 102-1 sends a MAC computed for the data using its MAC key (e.g., SK_B’s MAC_key).

At step 328, the orchestrator 110 verifies the received MAC using SK_R’s MAC key. Step 330 includes decrypting the data using SK_R’s encryption key. At step 332, the orchestrator 110 encrypts response data using its encryption key (e.g., SK_R’s encryption key) and sends the encrypted response data to the target device 102-1. At step 334, the orchestrator 110 sends a MAC computed for the response data using SK_R’s MAC key to the target device 102-1.

At step 336, the target device 102-1 verifies the MAC using SK_B’s MAC key, and at step 338, the target device 102-1 decrypts the response data using SK_B’s encryption key. This secure communication channel established through ECDH, for example, ensures that only the beacon of the target device 102-1 and the receiver of the orchestrator 110 can read or verify messages exchanged between them.

FIG. 4 shows a flow diagram of a process for secure device onboarding in an illustrative embodiment. It is to be understood that this particular process is only an example, and additional or alternative processes can be carried out in other embodiments. In this embodiment, the process includes steps 400 through 410. These steps are assumed to be performed by the orchestrator 110.

Step 400 includes sending an executable beacon to at least one target device in a distributed computing environment, wherein the executable beacon is configured to communicate with a receiver associated with a processor-based orchestrator of the distributed computing environment.

Step 402 includes obtaining data associated with one or more device characteristics of the at least one target device, wherein the data is obtained at the receiver from the executable beacon on the at least one target device.

Step 404 includes evaluating the one or more device characteristics relative to one or more onboarding criteria.

Step 406 includes generating one or more onboarding instructions for the target device based at least in part on a result of the evaluating.

Step 408 includes sending the one or more onboarding instructions to the target device.

Step 410 includes establishing a secure communication channel with the at least one target device by initiating an execution of the one or more onboarding instructions.

The executable beacon may be deployed on the at least one target device in response to sending the onboarding instructions to the target device.

The executable beacon may include a receiver address, a public key of the receiver, a unique beacon identifier, an expiration timestamp and/or configuration instructions for collecting the data associated with the one or more device characteristics.

The secure communication channel may be established based at least in part on a key agreement process. The key agreement process may include generating a first key pair at the receiver, including a public key from the first key pair in the executable beacon and computing a shared secret based on a second key pair generated by the executable beacon and the public key from the first key pair.

The key agreement process may include an ECDH key agreement process.

The one or more onboarding criteria may correspond to one or more processes executing on the at least one target device, a hardware configuration of the at least one target device, a device profile of the at least one target device, basic input/output system information and/or a result of one or more vulnerability scans.

The executable beacon may be terminated in response to the secure communication channel being established.

The onboarding instructions may correspond to a software package, where the software package comprises one or more software components for onboarding the target device, at least one configuration file and/or at least one configuration setting, one or more security updates and/or one or more firmware updates.

In some embodiments, the receiver may be hosted within the processor-based orchestrator. In other embodiments, the receiver may be hosted separately from the processor-based orchestrator.

Accordingly, the particular processing operations and other functionality described in conjunction with the flow diagram of FIG. 4 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. Some embodiments enable target devices (e.g., brownfield devices) to be securely integrated into modern distributed computing architectures, for example, without requiring complex client installations or manual configurations. These and other embodiments can effectively overcome technical challenges associated with onboarding target devices into modern computing environments. For example, some embodiments can effectively improve scalability by leveraging existing infrastructure for beacon deployment while maintaining security through encryption protocols, such as ECDH. The lightweight nature of the beacons and the validation driven by the onboarding criteria enables organizations to onboard large numbers of target devices efficiently, significantly reducing deployment times. Additionally, the ephemeral key pairs and self-terminating beacon mechanism ensure minimal exposure of sensitive information during the onboarding process, significantly reducing potential security risks compared to conventional techniques that rely on persistent client installations.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given such processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the information processing system 100. For example, containers can be used to implement respective processing devices providing compute and/or storage services of a cloud-based system. Again, containers may be used in combination with other virtualization infrastructure such as virtual machines implemented using a hypervisor.

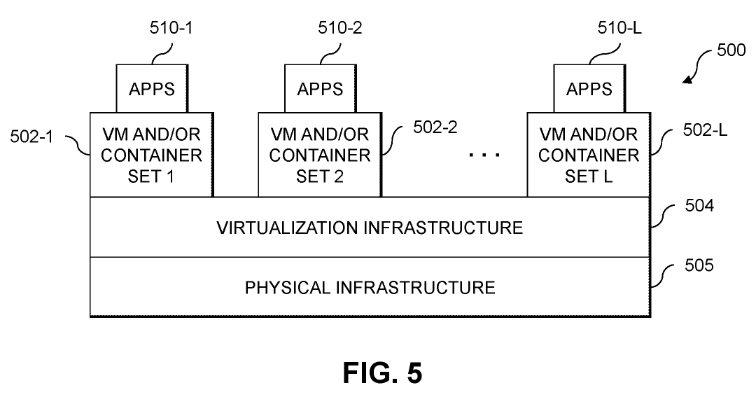

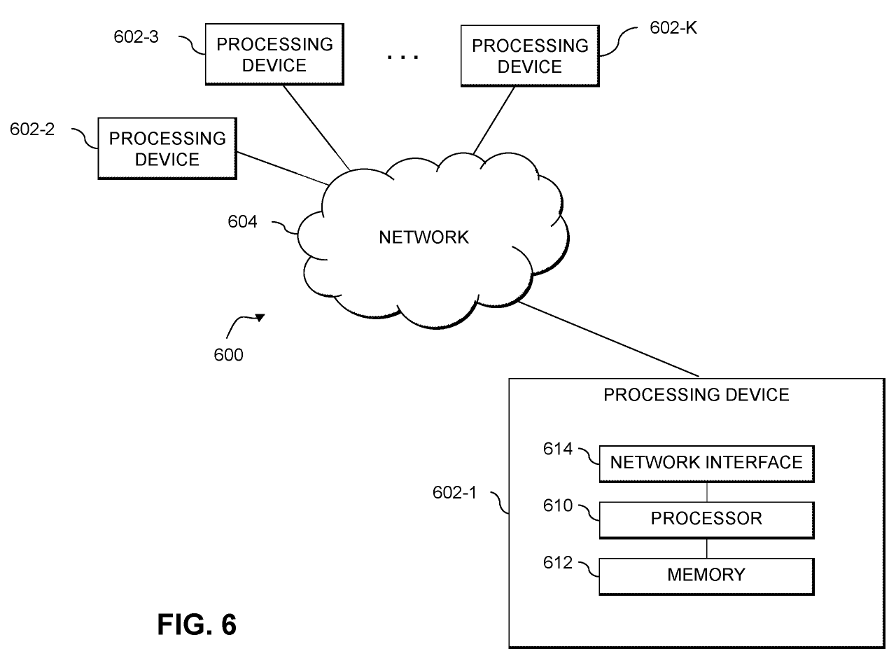

Illustrative embodiments of processing platforms will now be described in greater detail with reference to FIGS. 5 and 6. Although described in the context of the information processing system 100, these platforms may also be used to implement at least portions of other information processing systems in other embodiments.

FIG. 5 shows an example processing platform comprising cloud infrastructure 500. The cloud infrastructure 500 comprises a combination of physical and virtual processing resources that are utilized to implement at least a portion of the information processing system 100. The cloud infrastructure 500 comprises multiple virtual machines (VMs) and/or container sets 502-1, 502-2, . . . 502-L implemented using virtualization infrastructure 504. The virtualization infrastructure 504 runs on physical infrastructure 505, and illustratively comprises one or more hypervisors and/or operating system level virtualization infrastructure. The operating system level virtualization infrastructure illustratively comprises kernel control groups of a Linux operating system or other type of operating system.

The cloud infrastructure 500 further comprises sets of applications 510-1, 510-2, . . . 510-L running on respective ones of the VMs/container sets 502-1, 502-2, . . . 502-L under the control of the virtualization infrastructure 504. The VMs/container sets 502 comprise respective VMs, respective sets of one or more containers, or respective sets of one or more containers running in VMs. In some implementations of the FIG. 5 embodiment, the VMs/container sets 502 comprise respective VMs implemented using virtualization infrastructure 504 that comprises at least one hypervisor.

A hypervisor platform may be used to implement a hypervisor within the virtualization infrastructure 504, wherein the hypervisor platform has an associated virtual infrastructure management system. The underlying physical machines comprise one or more distributed processing platforms that include one or more storage systems.

In other implementations of the FIG. 5 embodiment, the VMs/container sets 502 comprise respective containers implemented using virtualization infrastructure 504 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of the information processing system 100 may each run on a computer, server, storage device or other processing platform element. A given such element is viewed as an example of what is more generally referred to herein as a “processing device.” The cloud infrastructure 500 shown in FIG. 5 may represent at least a portion of one processing platform. Another example of such a processing platform is processing platform 600 shown in FIG. 6.

The processing platform 600 in this embodiment comprises a portion of the information processing system 100 and includes a plurality of processing devices, denoted 602-1, 602-2, 602-3, . . . 602-K, which communicate with one another over a network 604.

The network 604 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 602-1 in the processing platform 600 comprises a processor 610 coupled to a memory 612.

The processor 610 comprises a microprocessor, a microcontroller, an ASIC, an FPGA, a CPU, a GPU, a TPU, a VPU, an NPU, a DPU, a SOC or other type of processing circuitry, as well as portions or combinations of such circuitry elements.

The memory 612 comprises RAM, ROM or other types of memory, in any combination. The memory 612 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage drive or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 602-1 is network interface circuitry 614, which is used to interface the processing device with the network 604 and other system components, and may comprise conventional transceivers.

The other processing devices 602 of the processing platform 600 are assumed to be configured in a manner similar to that shown for processing device 602-1 in the figure.

Again, the particular processing platform 600 shown in the figure is presented by way of example only, and the information processing system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of a distributed computing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
sending an executable beacon to at least one target device in a distributed computing environment, wherein the executable beacon is configured to communicate with a receiver associated with a processor-based orchestrator of the distributed computing environment;
obtaining data associated with one or more device characteristics of the at least one target device, wherein the data is obtained at the receiver from the executable beacon on the at least one target device;
evaluating the one or more device characteristics relative to one or more onboarding criteria;
generating one or more onboarding instructions for the target device based at least in part on a result of the evaluating;
sending the one or more onboarding instructions to the target device; and
establishing a secure communication channel with the at least one target device by initiating an execution of the one or more onboarding instructions;
wherein the method is performed by at least one processing device comprising a processor coupled to a memory.

2. The computer-implemented method of claim 1, wherein the executable beacon is deployed on the at least one target device in response to the sending.

3. The computer-implemented method of claim 1, wherein the executable beacon comprises one or more of:
a receiver address;
a public key of the receiver;
a unique beacon identifier;
an expiration timestamp; and
configuration instructions for collecting the data associated with the one or more device characteristics.

4. The computer-implemented method of claim 1, wherein the secure communication channel is established based at least in part on a key agreement process.

5. The computer-implemented method of claim 4, wherein the key agreement process comprises:
generating a first key pair at the receiver;
including a public key from the first key pair in the executable beacon; and
computing a shared secret based on a second key pair generated by the executable beacon and the public key from the first key pair.

6. The computer-implemented method of claim 4, wherein the key agreement process comprises an Elliptic Curve Diffie-Hellman (ECDH) key agreement process.

7. The computer-implemented method of claim 1, wherein the one or more onboarding criteria corresponds to at least one of:
one or more processes executing on the at least one target device;
a hardware configuration of the at least one target device;
a device profile of the at least one target device;
basic input/output system information; and
a result of one or more vulnerability scans.

8. The computer-implemented method of claim 1, wherein the executable beacon is terminated in response to the secure communication channel being established.

9. The computer-implemented method of claim 1, wherein the one or more onboarding instructions are associated with at least one of:
one or more software components for onboarding the target device;
one or more of at least one configuration file and at least one configuration setting;
one or more security updates; and
one or more firmware updates.

10. The computer-implemented method of claim 1, wherein the receiver is hosted within the processor-based orchestrator.

11. The computer-implemented method of claim 1, wherein the receiver is hosted separately from the processor-based orchestrator.

12. A non-transitory processor-readable storage medium having stored therein program code of one or more software programs, wherein the program code when executed by at least one processing device causes the at least one processing device:
to send an executable beacon to at least one target device in a distributed computing environment, wherein the executable beacon is configured to communicate with a receiver associated with a processor-based orchestrator of the distributed computing environment;
to obtain data associated with one or more device characteristics, wherein the data is obtained at the receiver from the executable beacon on the at least one target device;
to evaluate the one or more device characteristics against one or more onboarding criteria;
to generate one or more onboarding instructions for the target device based at least in part on a result of the evaluating;
to send the one or more onboarding instructions to the target device; and
to establish a secure communication channel with the at least one target device by executing the onboarding instructions.

13. The non-transitory processor-readable storage medium of claim 12, wherein the executable beacon is deployed on the at least one target device in response to the sending.

14. The non-transitory processor-readable storage medium of claim 12, wherein the executable beacon comprises:
a receiver address;
a public key of the receiver;
a unique beacon identifier;
an expiration timestamp; and
configuration instructions for collecting the data associated with the one or more device characteristics.

15. The non-transitory processor-readable storage medium of claim 12, wherein the secure communication channel is established based at least in part on a key agreement process.

16. The non-transitory processor-readable storage medium of claim 15, wherein the key agreement process comprises:
generating a first key pair at the receiver;
including a public key from the first key pair in the executable beacon; and
computing a shared secret based on a second key pair generated by the executable beacon and the public key from the first key pair.

17. An apparatus comprising:
at least one processing device comprising a processor coupled to a memory;
the at least one processing device being configured:
to send an executable beacon to at least one target device in a distributed computing environment, wherein the executable beacon is configured to communicate with a receiver associated with a processor-based orchestrator of the distributed computing environment;
to obtain data associated with one or more device characteristics, wherein the data is obtained at the receiver from the executable beacon on the at least one target device;
to evaluate the one or more device characteristics against one or more onboarding criteria;
to generate one or more onboarding instructions for the target device based at least in part on a result of the evaluating;
to send the one or more onboarding instructions to the target device; and
to establish a secure communication channel with the at least one target device by executing the onboarding instructions.

18. The apparatus of claim 17, wherein the executable beacon is deployed on the at least one target device in response to the sending.

19. The apparatus of claim 17, wherein the executable beacon comprises:
a receiver address;
a public key of the receiver;
a unique beacon identifier;
an expiration timestamp; and
configuration instructions for collecting the data associated with the one or more device characteristics.

20. The apparatus of claim 17, wherein the secure communication channel is established based at least in part on a key agreement process.
